(19) United States
(12) Patent Application Publication
(10) Pub. No.: US 2014/0314193 A1
(43) Pub. Date: Oct. 23, 2014

(54) WIRELESS DATA RECEIVING DEVICE AND A METHOD OF RECEIVING WIRELESS DATA USING THE SAME

(71) Applicant: Samsung Electronics Co., Ltd., Suwon-si (KR)

(72) Inventor: Hyuk-Jun Sung, Seongnam-si (KR)

(73) Assignee: SAMSUNG ELECTRONICS CO., LTD., Suwon-si (KR)

(21) Appl. No.: 14/254,502

(22) Filed: Apr. 16, 2014

(30) Foreign Application Priority Data
Apr. 17, 2013 (KR) 10-2013-0042339

(51) Int. Cl. H04L 7/033; H04B 5/00

(52) U.S. Cl. CPC H04L 7/0331; H04L 7/0337; H04B 5/00
USPC 375/376; 375/373

(57) ABSTRACT

A method of receiving wireless data is provided. The method includes generating a plurality of local clocks having different delayed phases with respect to a carrier wave during a carrier wave period and receiving a data packet using the plurality of local clocks. The plurality of local clocks includes at least a first local clock and a second local clock. The first local clock has a 0 degree delayed phase with respect to the carrier wave. The second local clock has a 90 degree delayed phase with respect to the carrier wave.

### CROSS-REFERENCE TO RELATED APPLICATION

This U.S. application claims priority under 35 U.S.C. §119 to Korean Patent Application No. 10-2013-0042339, filed on Apr. 17, 2013, in the Korean Intellectual Property Office (KIPO), the disclosure of which is incorporated by reference herein in its entirety.

### TECHNICAL FIELD

Exemplary embodiments of the present inventive concept relate to a wireless communication system, and more particularly to a wireless receiving device or a method of receiving wireless data using the same.

### DISCUSSION OF THE RELATED ART

A near field communication (NFC) has been used due to its high security in a short distance applications. A reader using the NFC may decode a protocol type from a received data packet and search a synchronization pattern before receiving a data pattern. It may be required for the reader to track a phase of the received data packet or to determine an optimized local clock to maximize a receiving efficiency of the reader.

### SUMMARY

According to an exemplary embodiment of the present inventive concept, a method of receiving wireless data is provided. The method includes generating a plurality of local clocks having different delayed phases with respect to a carrier wave during a carrier wave period and receiving a data packet using the plurality of local clocks. The plurality of local clocks includes a first local clock and a second local clock. The first local clock has a 0 degree delayed phase with respect to the carrier wave. The second local clock has a 90 degree delayed phase with respect to the carrier wave.

In an embodiment, the receiving the data packet may include obtaining power levels of a plurality of signals generated by mixing each of a plurality of sub patterns of a preamble pattern with a corresponding one of the plurality of local clocks, determining a local clock that generates a maximum power level based on the obtained power levels, searching a start pattern based on the determined local clock that generates the maximum power level, and receiving a data section of the data packet based on the searched start pattern. The preamble pattern may be located in a preamble transmission period of the data packet.

In an embodiment, the preamble transmission period may include a first preamble period and a second preamble period. Each of the power levels of the plurality of signals may be obtained during a corresponding one of a plurality of sub periods of the first preamble transmission period. The start pattern may be searched during the second preamble period following the first preamble period.

In an embodiment, each of the plurality of local clocks may correspond to one of the plurality of sub patterns. Each of the plurality of sub patterns may correspond to one of the plurality of sub periods. Each of the plurality of sub periods may correspond to one of the plurality of signals.

In an embodiment, the data packet may be formed according to a TypeA 106 communication protocol or a TypeB 106 communication protocol.

In an embodiment, each of the power levels of the plurality of signals may be obtained during entire period of the preamble transmission period. The start pattern may be searched during a synchronization period following the preamble period.

In an embodiment, the data packet may be formed according to a TypeF 212 communication protocol or a TypeF 424 communication protocol.

According to an exemplary embodiment of the present inventive concept, a wireless data receiving device of a reader is provided. The wireless data receiving device includes an all digital phase-locked loop (ADPLL) and an analog receiving unit. The ADPLL is configured to generate a plurality of local clocks having different delayed phases with respect to a carrier wave during a carrier wave period. The analog receiving unit is configured to receive a data packet using the plurality of local clocks. The plurality of local clocks includes a first local clock and a second local clock. The first local clock has a 0 degree delayed phase with respect to the carrier wave and the second local clock has a 90 degree delayed phase with respect to the carrier wave.

In an embodiment, the analog receiving unit may be configured to convert the data packet into first data during a plurality of sub periods of a preamble transmission period or second data during a data transmission period. The first data may include a plurality of sub first data generated by at least mixing each of a plurality of sub patterns of a preamble pattern with a corresponding one of the plurality of local clocks. The preamble pattern may be located in the preamble transmission period.

In an embodiment, the wireless data receiving device may further include a digital processing unit. The digital processing unit may include a phase control unit configured to obtain power levels of the plurality of sub first data. The phase control unit may further be configured to determine a local clock that generates a maximum power level based on the obtained power levels.

In an embodiment, each of the plurality of local clocks may correspond to one of the plurality of sub patterns. Each of the plurality of sub patterns may correspond to one of the plurality of sub periods. Each of the plurality of sub periods may correspond to one of the plurality of sub first data.

In an embodiment, the digital processing unit may further include a sampling block configured to search a start pattern using the determined local clock that generates the maximum power level to receive a data section of the data packet based on the searched start pattern, and to generate a detection signal and an internal data signal.

In an embodiment, the sampling block may further include a plurality of filters, a peak detector, a bit measurer, and a start pattern. The plurality of filter may be configured to filter the first data and the second data. The peak detector may be configured to perform a peak detecting operation to outputs of the plurality of filters. The bit measurer may be configured to perform a bit measuring operation to an output of the peak detector. The start pattern searcher may be configured to analyze an output of the bit measurer to generate a plurality of pattern data based on the plurality of sub first data, and to generate the detection signal and the internal data signal based on the second data.

In an embodiment, the phase control unit may include a partial bit searcher, an integration filter, a storing unit, and a phase decision unit. The partial bit searcher may be configured to search partial bits of N bits of each of the plurality of pattern data, N is a positive integer equal to two or greater. The integration filter may be configured to integrate the searched partial bits and to obtain the power levels of plurality of sub first data. The storing unit may be configured to store the obtained power levels. The phase decision unit may be configured to determine the local clock that generates the maximum power level based on the power levels stored in the storing unit, and to provide a phase control signal to the ADPLL. The phase control signal may indicate the local clock that generates the maximum power level.

In an embodiment, the preamble transmission period may include a first preamble period and a second preamble period. The plurality of sub periods may be located in the first preamble period of the preamble transmission period when the data packet is formed according to a TypeA 106 communication protocol or a TypeB 106 communication protocol.

In an embodiment, the plurality of sub periods may be located in the entire preamble transmission period when the received data packet is formed according to a TypeF 212 communication protocol or a TypeF 242 communication protocol.

According to an exemplary embodiment of the present inventive concept, a wireless data receiving device is provided. The device includes an all digital phase-locked loop (ADPLL), an analog receiving unit, and a digital processing unit. The ADPLL is configured to generate a plurality of local clocks having different delayed phases with respect to a carrier wave during a carrier wave period. The analog receiving unit is configured to receive a data packet, to mix each of a plurality of a sub patterns of a preamble pattern with a corresponding one of the plurality of local clocks, and to generate each of a plurality of sub first data during a corresponding one of a plurality of sub periods of a preamble transmission period. The digital processing unit is configured to determine a maximum local clock of the plurality of local clock based on the plurality of sub first data, and to provide information of the maximum local clock to the ADPLL. The maximum local clock is a local clock mixed with a sub first data having a maximum power level. The plurality of local clocks includes a first local clock and a second local clock. The first local clock has a 0 degree delayed phase with respect to the carrier wave and the second local clock has a 90 degrees delayed phase with respect to the carrier wave. The preamble pattern is located in the preamble transmission period.

In an embodiment, the digital processing unit may further include a phase control unit. The phase control unit may be configured to obtain power levels of the plurality of sub first data, and to determine the maximum local clock based on the obtained power levels.

In an embodiment, the preamble transmission period may include a first preamble period and a second preamble period. Each of the plurality of sub patterns may correspond to one of the plurality of sub period. The plurality of sub periods may be located in the first preamble period of the preamble transmission period when the received data packet is formed according to a TypeA 106 communication protocol or a TypeB 106 communication protocol.

### BRIEF DESCRIPTION OF THE DRAWINGS

FIG. 1 is a diagram illustrating a NFC system including a wireless data receiving device and a card according to an exemplary embodiment of the present inventive concept.

FIG. 2 illustrates a timing map used in a NFC system of FIG. 1 according to an exemplary embodiment of the present inventive concept.

FIG. 3 illustrates an exemplary configuration of a data packet exchanged in a NFC system according to an exemplary embodiment of the present inventive concept.

FIG. 4 is a flow chart illustrating a method of receiving wireless data, according to an exemplary embodiment of the present inventive concept.

FIGS. 5 and 6 are amplitude diagrams of data received at the reader according to an exemplary embodiment of the present inventive concept.

FIGS. 7 and 8 are amplitude diagrams of data received at the reader according to an exemplary embodiment of the present inventive concept.

FIG. 9 illustrates a configuration of a data section of FIG. 3 according to various communication protocols used in a received data packet, according to an exemplary embodiment of the present inventive concept.

FIG. 10 illustrates a configuration of the data packet in FIG. 3 according to an exemplary embodiment of the present inventive concept.

FIG. 11 illustrates a configuration of the data packet in FIG. 3 according to an exemplary embodiment of the present inventive concept.

FIG. 12 illustrates a configuration of the data packet in FIG. 3 according to an exemplary embodiment of the present inventive concept.

FIG. 13 is a block diagram illustrating an NFC reader including a wireless data receiving device according to an exemplary embodiment of the present inventive concept.

FIG. 14 is a block diagram illustrating an analog receiving unit in FIG. 13 according to an exemplary embodiment of the present inventive concept.

FIG. 15 is a block diagram illustrating a sampling block in FIG. 13 according to an exemplary embodiment of the present inventive concept.

FIG. 16 is a block diagram illustrating a phase control unit in FIG. 13 according to an exemplary embodiment of the present inventive concept.

FIG. 17 is a block diagram illustrating a wireless communication system according to an exemplary embodiment of the present inventive concept.

FIG. 18 is illustrates a second terminal included in the wireless communication system shown in FIG. 17 according to an exemplary embodiment of the present inventive concept.

### DETAILED DESCRIPTION OF THE EMBODIMENTS

Exemplary embodiments of the present inventive concept will be described in more detail with reference to the accompanying drawings, in which the exemplary embodiments are shown. These inventive concepts may, however, be embodied in various forms and should not be construed as being limited to the embodiments set forth herein. Like reference numerals may refer to like elements throughout this application.

It will be understood that when an element is referred to as being “connected” or “coupled” to another element, it can be directly connected or coupled to the other element or intervening elements may be present.

As used herein, the singular forms “a,” “an” and “the” are intended to include the plural forms as well, unless the context clearly indicates otherwise.

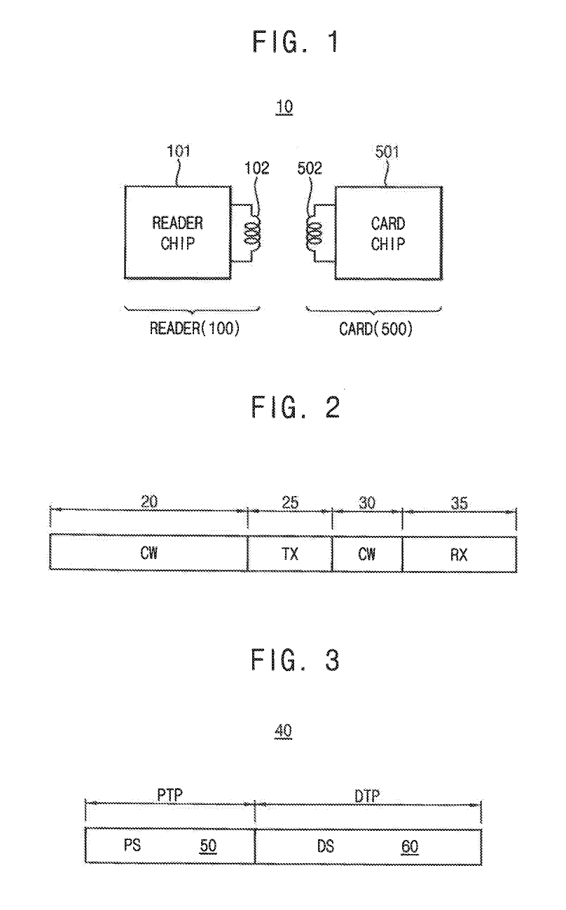

FIG. 1 is a diagram illustrating a NFC system including a wireless data receiving device according to an exemplary embodiment of the present inventive concept.

The NFC system 10 illustrated in FIG. 1 may be included in a wireless communication system, and the wireless communication system may transmit and receive data based on a NFC protocol. For example, according to ISO 14443, a wireless communication system may include a reader and a card that support the NFC protocol based on the ISO 14443 standard. According to ISO 18092, the wireless communication system may include an initiator and a target that support the NFC protocol based on the ISO 18092. In FIG. 1, a NFC system including a reader 100 and a card 500 is illustrated as an example.

Referring to FIG. 1, the NFC system 10 may include the reader 100 and the card 500. The reader 100 may include a reader chip 101 and a first antenna 102. The card 500 may include a card chip 501 and a second antenna 502. The reader 100 and the card 500 may exchange data with each other through the first and second antennas 102 and 502, and the card 500 may receive an electrical voltage signal transmitted from the first antenna 102 through the second antenna 502. The reader 100 and the card 500 may use one channel to exchange the data. The reader 100 may generate a plurality of local clocks during a carrier wave period in which the reader 100 transmits a carrier wave to the card 500. Each of the plurality of local clocks may have different delayed phases from each other. The plurality of local clocks may include a first local clock and a second local clock. The first local clock and the second local clock have delayed phases of 0 degrees and 90 degrees, respectively, with respect to the phase of the carrier wave.

FIG. 2 illustrates a timing map used in a NFC system of FIG. 1 according to an exemplary embodiment of the present inventive concept.

Referring to FIG. 2, periods defined in the NFC system may include a first carrier wave period 20, a transmission period 25, a second carrier wave period 30, and a reception period 35 which comes one after the other. The reader may 100 may transmit a first carrier wave CW1 without a data modulation to the card 500 during the first carrier wave period 20. The reader 100 may transmit data to the card 500 during the transmission period 25. Further, the card 500 may return the first carrier wave CW1 to the receiver 100 by performing a load modulation during the second carrier wave period 30. The reader 100 may receive a data packet from the card 500 data during the reception period 35.

FIG. 3 illustrates a data packet transmitted to the reader 100 from the card 500 during a data reception period, according to an exemplary embodiment of the present inventive concept.

Referring to FIG. 3, the data packet 40 received from the card 500 may include a preamble section 50 in a preamble transmission period PTP and a data section 60 in a data transmission period DTP. The preamble section 50 may be transmitted to the reader 100 from the card 500 during the preamble transmission period PTP of the reception period 35, and the data section 60 may be transmitted to the reader 100 from the card 500 during the data transmission period DTP of the reception period 35. The preamble section 50 may have a plurality of sub patterns which corresponds to one of a plurality of sub periods in the preamble transmission period PTP.

Referring back to FIG. 1, the reader 100 may receive a data packet and mix each of the plurality of sub patterns of the preamble section 50 with a corresponding one of the plurality of local clocks during the preamble transmission period PTP. Therefore, the reader 100 may generate a plurality of mixed signals and detect power levels of the same. The reader 100 may determine a local clock CLCK_MAX that generates a maximum power when it is mixed with a sub pattern of the preamble section 50 and search a start pattern based on the determined local clock CLCK_MAX to receive a data section 60 from the card 500. Accordingly, since the reader 100 receives the data packet from the card 500 using one channel, resources to process the data packet may be reduced and a receiving efficiency may be increased by receiving data using the local clock CLCK_MAX that generates a maximum power when it is mixed with a subs pattern of the preamble section 50.

For example, the reader 100 may generate at least a first local clock having a 0 degree delayed phase and a second local clock having a 90 degree delayed phase during the carrier wave period, and may receive the data packet from the card 500 using the first and second local clocks. In this case, the reader 100 may receive the data packet from the card 500 using two channels. That is, after receiving the data packet using the first and second local clocks, the reader 100 may determine a delayed phase according to whether an error occurs in the received data packet.

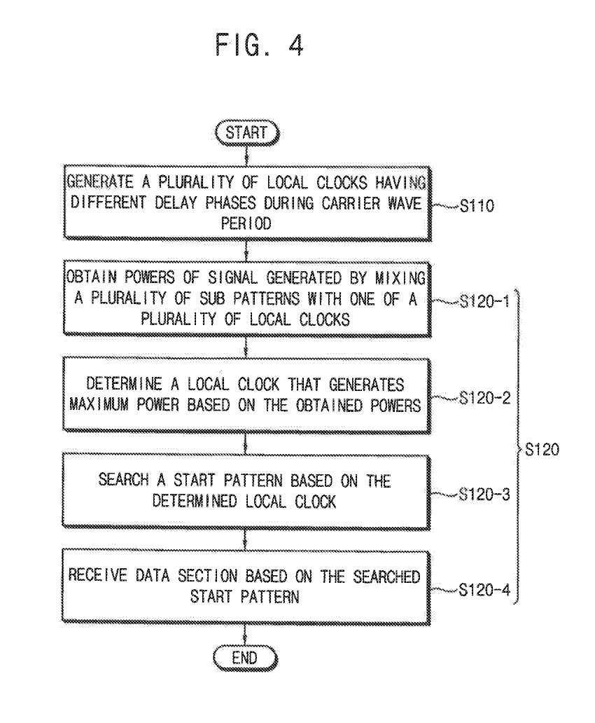

FIG. 4 is a flow chart illustrating a method of receiving a data packet by a NFC reader 100, according to an exemplary embodiment of the present inventive concept.

Referring to FIGS. 1 and 4, the method of receiving a data packet according to an exemplary embodiment of the present inventive concept may include: generating a plurality of local clocks having different delayed phases with respect to a carrier wave during a carrier wave period (S110); and receiving the data packet from the card 500 using the plurality of local clocks (S120).

In step S110, the carrier wave period may be a period in which the reader 100 transmits a carrier wave. The plurality of local clocks may include a first local clock and a second local clock. The first and second local clocks may have a 0 and 90 degrees delayed phases with respect to the carrier wave, respectively. In step S120, the reader 100 may obtain power levels of a plurality of signals generated by mixing each of a plurality of sub patterns of the preamble section 50 with a corresponding one of the plurality of local clocks (S120-1). The preamble section 50 may be included in the preamble transmission period PTP. The reader 100 may further determine a local clock that generates a maximum power level, based on the obtained power levels (S120-2), search a start pattern based on the determined local clock that generates the maximum power level (S120-3), and receive a data section of the data packet based on the searched start pattern (S120-4).

Each of the power levels of the plurality of signals may be obtained during a corresponding one of a plurality of sub periods in the preamble transmission period PTP. The start pattern may be searched during the second preamble period following the first preamble period. The first preamble period may be divided into a plurality of sub periods. For example, when the first and second local clocks serve as the plurality of local clocks, the first preamble period may be divided into a first sub period and a second sub period and each of the power levels of the signals generated by mixing each of the two sub patterns in the two sub periods with the local clock (e.g., the first local clock and the second local clock) may be obtained during a corresponding one of the two sub periods in the preamble transmission period.

When the received data packet is formed according to a TypeA 106 communication protocol or a TypeB 106 communication protocol, the data packet does not include a synchronization pattern. Therefore, the reader 100 may divide the preamble transmission period PTP into a first preamble period and a second preamble period, divide the first preamble period again into the plurality of sub periods, obtain each of the power levels of the plurality of signals during a corresponding one of the plurality of sub periods, and determine a local clock CLCK_MAX that generates a maximum power when it is mixed with one of the plurality of sub patterns. The reader 100 may use the local clock CLCK_MAX to search the start pattern and receive the data section 60 during the second preamble period.

When the received data packet is formed according to a TypeF 212 communication protocol or a TypeF 424 communication protocol, the reader 100 may obtain each of the power levels of the plurality of signals during a corresponding one of the plurality of sub periods. The plurality of sub periods may be located in the entire preamble period. Further, the reader 100 may determine the local clock CLCK_MAX that generates a maximum power when it is mixed with one of the plurality of sub patterns. The reader 100 may use the local clock CLCK_MAX to search the start pattern in the synchronization section following the preamble section and receive the data section 60.

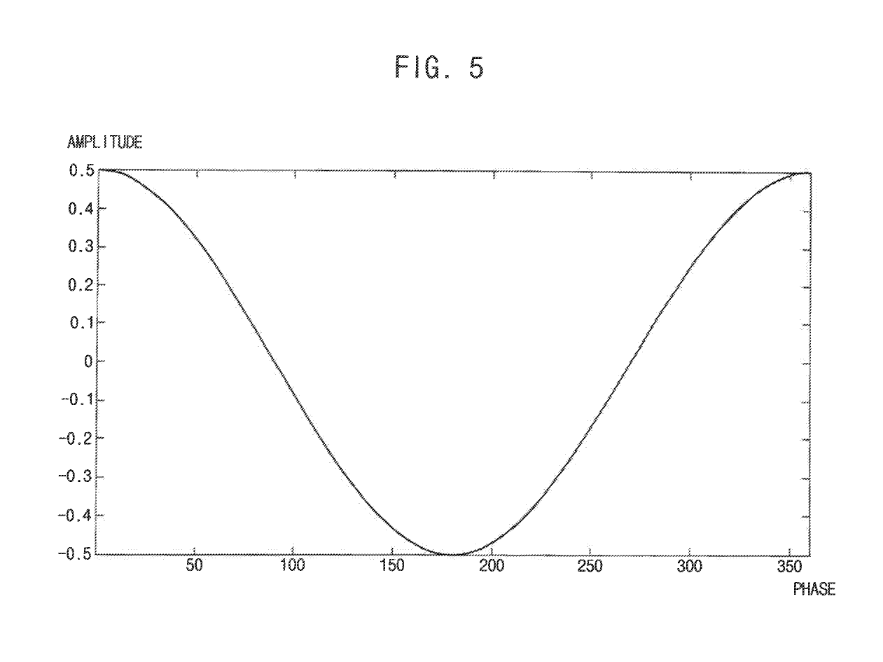

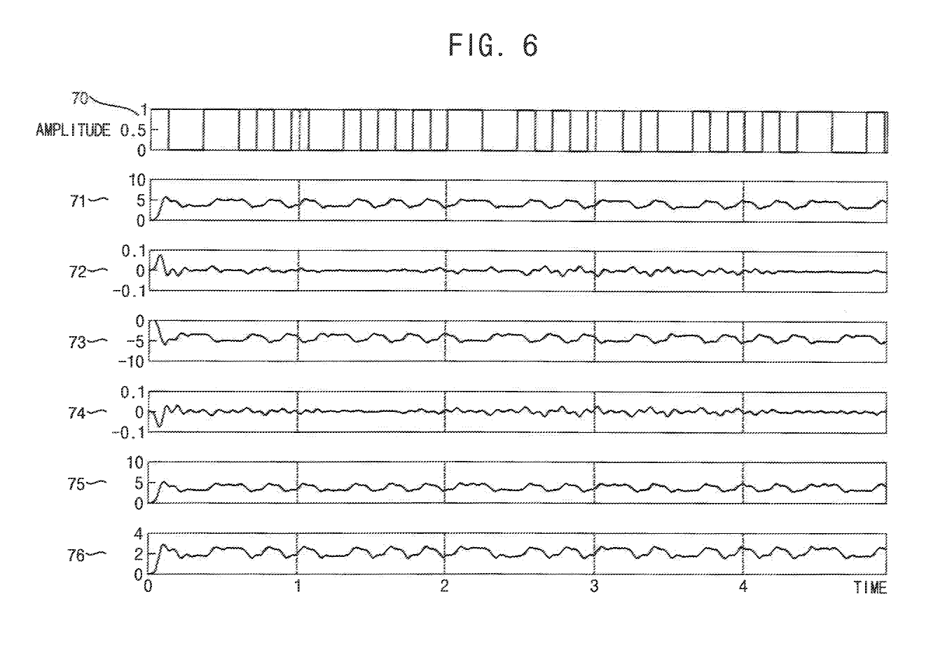

FIGS. 5 and 6 are amplitude diagrams of data received at the reader according to an exemplary embodiment of the present inventive concept.

When received data ‘1’ and ‘0’ at the reader 100 are represented as A sin(ωt+θ) and A′ sin(ωt+θ), respectively, A sin(ωt+θ) and A′ sin(ωt+θ) may be mixed with a local clock represented as sin(ωt), and passed through a low-pass filter. Accordingly, an output amplitude of the low-pass filter may be formulated by equation 1 shown below.

((A−A′)/2)*cos θ, [equation 1]

where A and A′ are peak amplitudes of the received data ‘1’ and ‘0’, respectively, and θ is a difference in phase of the received data and the local clock. As illustrated in FIG. 5, the output amplitude of the low-pass filter ((A−A′)/2)*cos θ as a function of θ changes when A−A′ corresponds to one. As illustrated in FIG. 5, the output amplitude of the low-pass filter may be maximized when θ is about 0 degrees or 180 degrees. The output amplitude of the low-pass filter may be zero when θ is about 90 degrees or 270 degrees.

FIG. 6 illustrates output amplitude diagrams of the low-pass filter as a function of time according to various delayed phases.

Referring to FIG. 6, a reference numeral 70 indicates an amplitude diagram of the received data, a reference numeral 71 indicates an amplitude diagram when θ is 0 degrees, a reference numeral 72 indicates an amplitude diagram when θ is 90 degrees, a reference numeral 73 indicates an amplitude diagram when θ is 180 degrees, a reference numeral 74 indicates an amplitude diagram when θ is 270 degrees, a reference numeral 75 indicates an amplitude diagram when θ is 30 degrees, and a reference numeral 76 indicates an amplitude diagram when θ is 60 degrees. As illustrated in FIG. 6, the amplitude may be maximized when θ is 0 degrees or 180 degrees, and the amplitude may be minimized when θ is 90 degrees or 270 degrees. Since an amplitude level is proportional to a power level, an output power of the low-pass filter may be maximized when θ is about 0 degrees or 180 degrees, or an output power of the low-pass filter may be minimized when θ is about 90 degrees or 270 degrees.

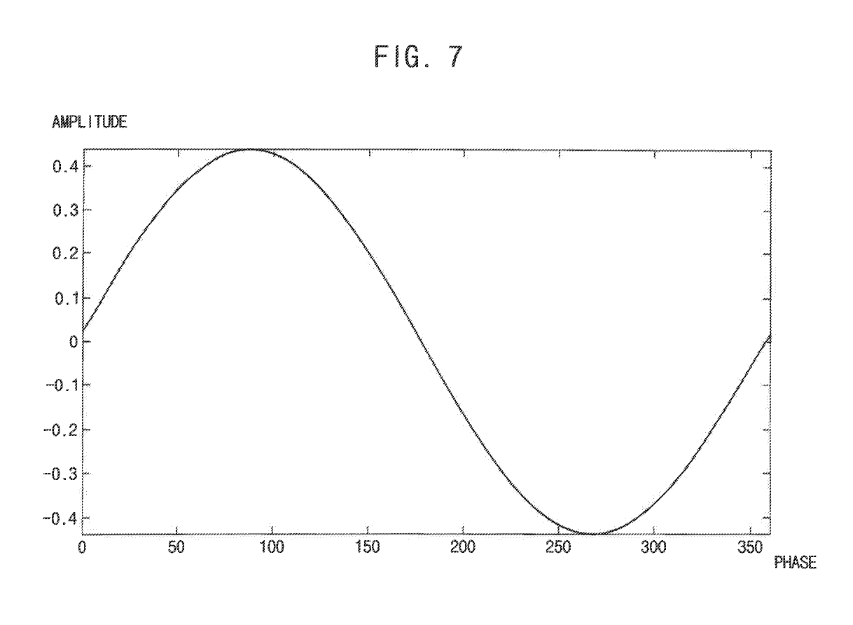

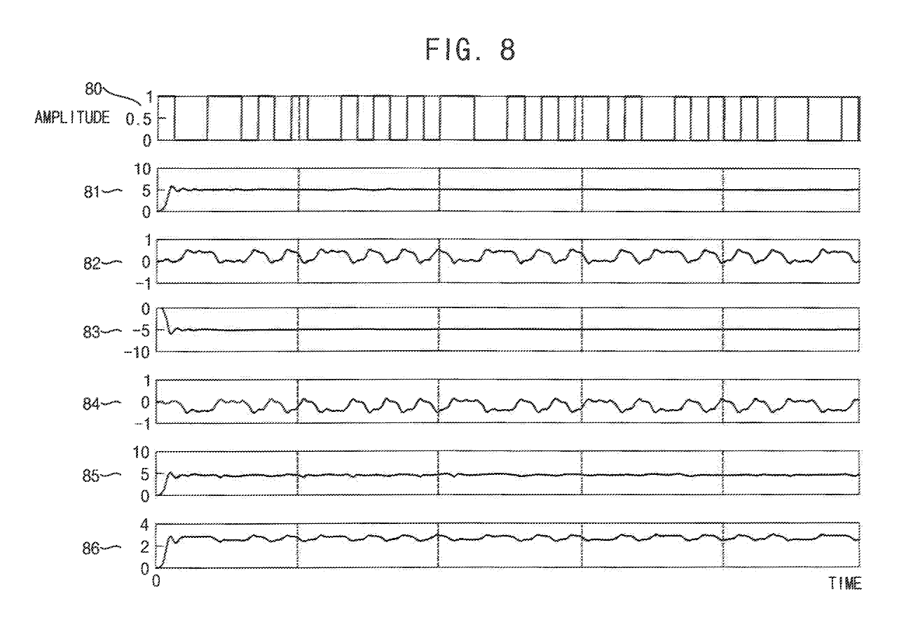

FIGS. 7 and 8 are amplitude diagrams of data received at the reader according to an exemplary embodiment of the present inventive concept.

When received data ‘1’ and ‘0’ at the reader 100 are represented as A sin(ωt+θ) and A sin(ωt+θ+a), respectively, A sin(ωt+θ) and A sin(ωt+θ+a) are mixed with a local clock represented as sin(ωt), and passed through a low-pass filter. Accordingly, an output amplitude of the low-pass filter may be formulated by equation 2 shown below.

(A/2)*(cos θ−cos(θ+a)), [equation 2]

where A is a peak amplitude of the received data ‘1’ and ‘0’, θ is a difference in phase of the received data and the local clock, and a is a difference in phase of the received data ‘1’ and ‘0’.

FIG. 7 illustrates an output amplitude of the low-pass filter (A/2)*(cos θ−cos(θ+a)) as a function of θ when a is 5 degrees. As illustrated in FIG. 7, the output amplitude of the low-pass filter may be maximized when θ is about 90 degrees or 270 degrees. The output amplitude of the low-pass filter may be minimized when θ is about 0 degrees or 180 degrees.

FIG. 8 illustrates output amplitude diagrams of the low-pass filter as a function of time according to various delayed phases.

Referring to FIG. 8, a reference numeral 80 indicates an amplitude diagram of the received data, a reference numeral 81 indicates an amplitude diagram when θ is 0 degrees, a reference numeral 82 indicates an amplitude diagram when θ is 90 degrees, a reference numeral 83 indicates an amplitude diagram when θ is 180 degrees, a reference numeral 84 indicates an amplitude diagram when θ is 270 degrees, a reference numeral 85 indicates an amplitude diagram when θ is 30 degrees, and a reference numeral 86 indicates an amplitude diagram when θ is 60 degrees. As illustrated in FIG. 8, the amplitude may be maximized when θ is 90 degrees or 270 degrees, and the amplitude may be minimized when θ is 0 degrees or 180 degrees. Since an amplitude level is proportional to a power level, an output power of the low-pass filter may be maximized when θ is about 90 degrees or 270 degrees, or an output power of the low-pass filter may be minimized when θ is about 0 degrees or 180 degrees.

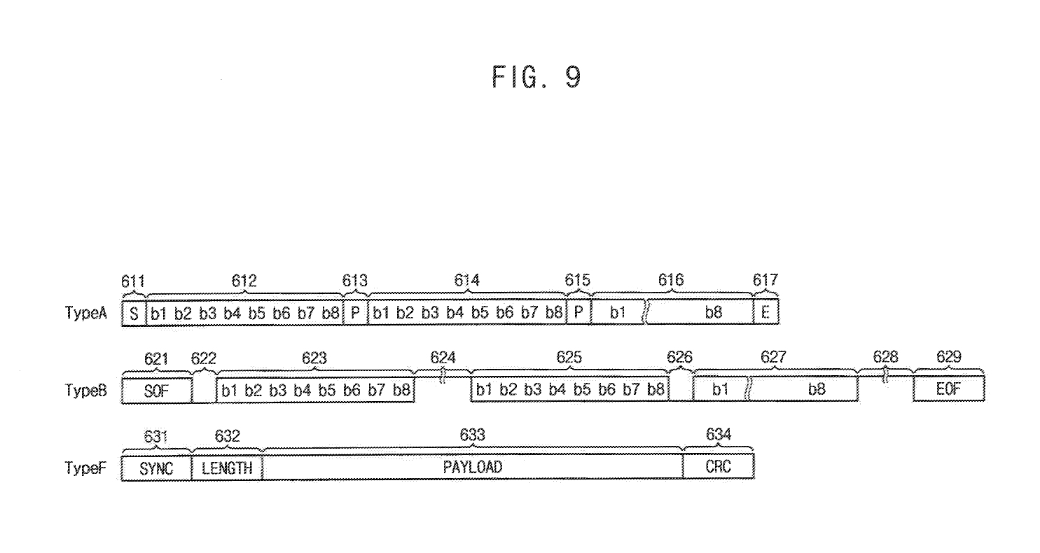

FIG. 9 illustrates a configuration of a data section of FIG. 3 according to various communication protocols used in a received data packet.

Referring to FIG. 9, “TypeA” represents a configuration of the data section 60 when the received data packet 40 is formed according to a TypeA 106 protocol, “TypeB” represents a configuration of the data section 60 when the received data packet 40 is formed according to a TypeB 106 protocol, and “TypeF” represents a configuration of the data section 60 when the received data packet 40 is formed according to a TypeF 212 protocol or a TypeF 424 protocol.

For example, the received data packet 40 may include a mode pattern and a data pattern. The mode pattern may include information of the communication protocol used in the received data packet 40 and the data pattern may correspond to effective data of the received data packet 40.

When the received data packet 40 is formed according to the TypeA 106 protocol, the data section 60 may include a start bit (S) 611, data patterns 612, 614 and 616, parity patterns 613 and 615, and an end bit 617. the start bit 611 may correspond to the mode pattern and the data bit patterns 612, 614, and 616 may correspond to the effective data of the received data packet 40.

When the received data packet 40 is formed according to the TypeB 106 protocol, the data section 60 may include a file start pattern (SOF) 621, data bit patterns 623, 625 and 627, start sections 622 and 626, stop sections 624 and 628, and a file end pattern 629. In this case, the file start pattern 621 may correspond to the mode pattern and the data bit patterns 623, 625 and 627 may correspond to the effective data of the received data packet 40.

When the received data packet 40 is formed according to the TypeF212 protocol or TypeF424 protocol, the data section 60 may include a sync pattern (SYNC) 631, a length pattern 632, a payload pattern 633, and a CRC pattern 634. The sync pattern 631 may correspond to the mode pattern and the payload pattern 633 may correspond to the effective data of the received data packet 40.

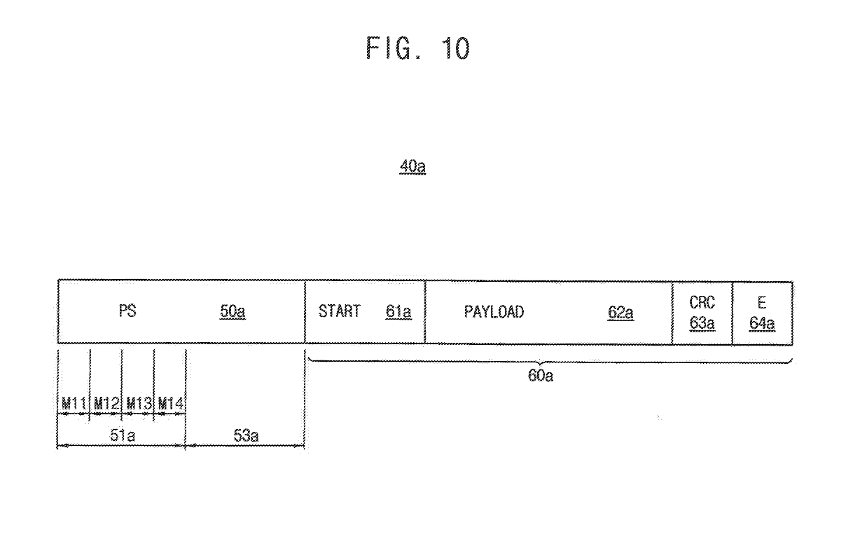

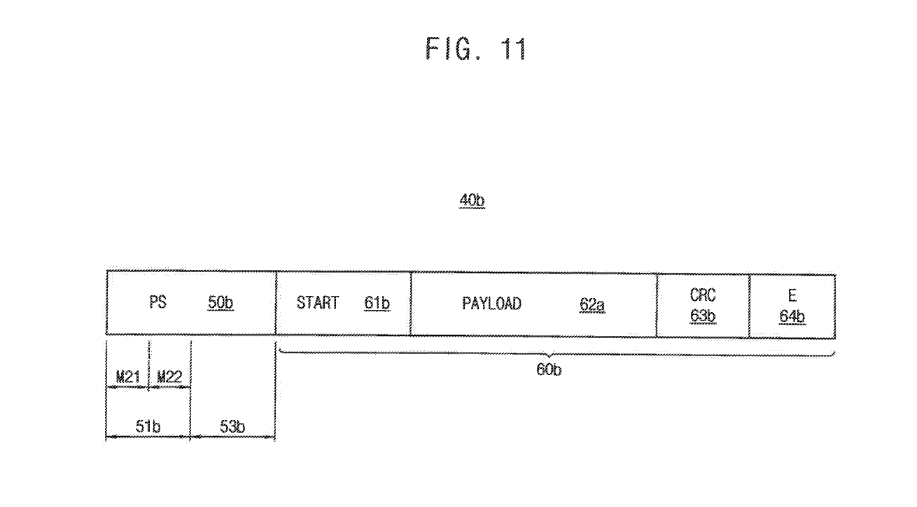

Hereinafter, a configuration of a received data packet formed based on the TypeA 106 protocol or the TypeB according to an exemplary embodiment of the present inventive concept will be described in detail with reference to FIGS. 10 and 11.

FIG. 10 illustrates a configuration of a received data packet in FIG. 3 according to an exemplary embodiment of the present inventive concept.

As illustrated in FIG. 10, a received data packet 40a may include a preamble section 50a and a data section 60a. Referring back to FIGS. 2 and 3, the data section 60a may be received in the data transmission period DTP and include a start pattern 61a, a payload pattern 62a, CRC pattern 63a, and an end pattern 64a.

Referring back to FIGS. 2 and 3, the preamble section 50a may be received in the preamble transmission period PTP. The preamble section 50a may include a plurality of sub patterns. Each of the plurality of sub patterns may include a regular pattern. The preamble transmission period PTP may include a first and a second preamble periods 51a and 53a. The first preamble period 51a may be divided into a plurality of sub periods M11, M12, M13, and M14. The sub periods M1, M12, M13, and M14 may include a corresponding one of the plurality of sub patterns. When the reader 100 receives the data packet 40a of FIG. 10 from the card 500 during the reception period 35, the reader 100 may mix each of the plurality of sub patterns in the first preamble period 51a with a corresponding one of the plurality of local clocks. Referring back to FIG. 2, the plurality of local clocks may be generated by the reader during the carrier wave period 20 and have different delayed phases (e.g., 0 degrees, 20 degrees, 45 degrees, and 90 degrees). The reader 100 may determine a local clock CLCK_MAX that generates a maximum output power when it is mixed with a corresponding one of the plurality of sub regular patterns of the preamble section 50a. The determined local clock CLCK_MAX may be used to search a start pattern 61a during the second preamble period 53a, and thus, receive the data section 60a. For example, the preamble section 50a may include 64-bit data ‘0’ as the regular pattern. Therefore, the reader 100 may mix each 8-bit data ‘0’ in the sub periods M11, M12, M13 and M14 with a corresponding one of the plurality of local clocks, and determine the local clock CLCK_MAX having the maximum amplitude. The reader may search the start pattern 61a using the local clock CLCK_MAX during the second preamble period 53a in which the 32-bit data ‘0’ is received.

FIG. 11 illustrates a configuration of a received data packet in FIG. 3 according to an exemplary embodiment of the present inventive concept.

As illustrated in FIG. 11, a data packet 40b may include a preamble section 50a and a data section 60b. Referring back to FIGS. 2 and 3, the data section 60b may be received in the data transmission period DTP and include a start pattern 61b, a payload pattern 62b, CRC pattern 63b, and an end pattern 64b.

Referring back to FIGS. 2 and 3, the preamble section 50b may be received in the preamble transmission period PTP. The preamble section 50b may include two sub patterns. Each of the two sub patterns may include a regular pattern. The preamble transmission period PTP may include first and second preamble periods 51b and 53b. The first preamble period 51b may be divided into first and second sub periods M21 and M22. The sub periods M21 and M22 may include a corresponding one of the two sub patterns. When the reader 100 receives the data packet 40b of FIG. 11 from the card 500 during the reception period 35, the reader 100 may mix each of the two patterns in the first preamble period 51b with a corresponding one of the first local clock and second local clocks. Referring back to FIG. 2, the first and the second local clocks may be generated by the reader 100 during the carrier wave period 20 and have different delayed phases from each other (e.g., 0 degrees, 90 degrees). The reader 100 may determine a local clock CLCK_MAX that generates a maximum output power when it is mixed with one of the two sub patterns of the preamble section 50b. The determined local clock CLCK_MAX may be used to search a start pattern 61b during the second preamble period 53b, and thus, receive the data section 60b. For example, the preamble section 50a may include 32-bit data ‘0’ as the regular pattern. Therefore, the reader 100 may mix each 8-bit data ‘0’ in the first and second sub periods M21 and M22 with one of the first and the second local clocks, and determine a local clock CLCK_MAX that generates a maximum output power when it is mixed with a sub regular pattern of the preamble pattern. The reader may search the start pattern 61b using the determined local clock CLCK_MAX during the second preamble period 53b in which the 16-bit data ‘0’ is received.

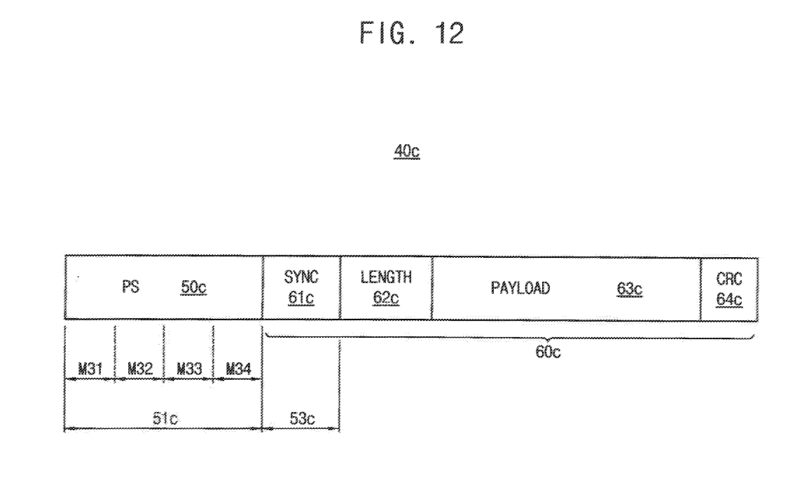

Hereinafter, a configuration of a received data packet formed based on the TypeF 212 protocol or the TypeF 424 protocol according to an exemplary embodiment of the present inventive concept will be described in detail with reference to FIG. 12.

FIG. 12 illustrates a configuration of a received data packet in FIG. 3 according to an exemplary embodiment of the present inventive concept.

As illustrated in FIG. 12, a received data packet 40c may include a preamble section 50c, and a data section 60c. Referring back to FIGS. 2 and 3, the data section 60c may be received in the data transmission period DTP and include a sync pattern 61c as a start pattern, a length pattern 62c, a payload pattern 63c, and a CRC pattern 64c.

Referring back to FIGS. 2 and 3, the preamble section 50c may be received in the preamble transmission section PTP. The preamble section 50c may include a plurality of sub patterns. Each of the plurality of sub patterns may include a regular pattern. The entire preamble transmission period PTP may be divided into a plurality of sub periods M31, M32, M33 and M34. The sub periods M31, M32, M33, and M34 may include a corresponding one of the plurality of sub patterns. When the reader 100 receives the data packet 40c of FIG. 12 from the card 500 during the data reception period 35, the reader 100 may mix each of the plurality of sub patterns in the preamble transmission period PTP with a corresponding one of the plurality of local clocks. Referring back to FIG. 2, the plurality of local clocks may be generated by the reader 100 during the carrier wave period 20 and have different delayed phases (e.g., 0 degrees, 20 degrees, 45 degrees, and 90 degrees). The reader 100 may determine a local clock CLCK_MAX that generates a maximum output power when it is mixed with a corresponding one of the plurality of sub patterns of the preamble section 50c. The determined local clock CLCK_MAX may be used to search a sync pattern 61c during the period 53c, and thus, receive the data section 60c. For example, the preamble section 50c may include 64-bit data ‘0’ as the regular pattern. Therefore, the reader 100 may mix each 8-bit data ‘0’ in the sub periods M31, M32, M33 and M34 with a corresponding one of the plurality of local clocks, and determine a local clock CLCK_MAX that generates a maximum output power when it is mixed with a sub regular pattern of the preamble section. The reader 100 may search the sync pattern 61c using the determined local clock CLCK_MAX during the period 53c in which the sync pattern 61c is transmitted.

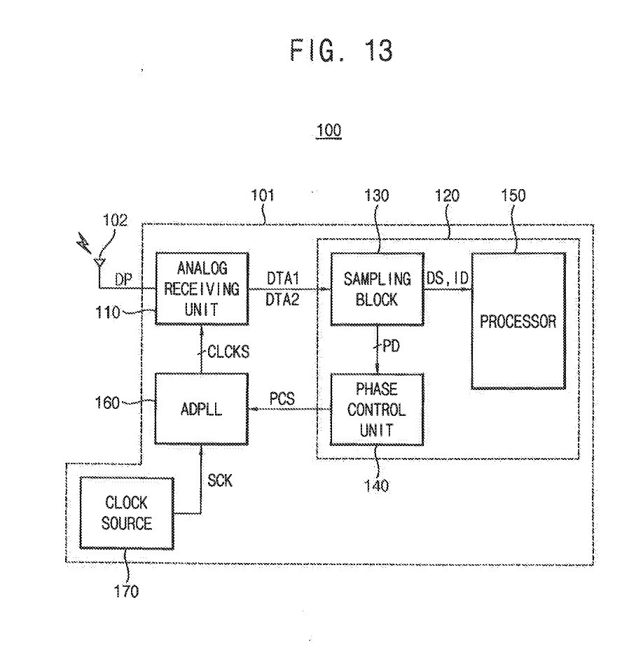

FIG. 13 is a block diagram illustrating a reader including a wireless data receiving device according to an exemplary embodiment of the present inventive concept.

Referring to FIG. 13, the reader 100 may include an antenna 102 and a wireless data receiving device 101 (or a reader chip). The wireless data receiving device 101 may include an analog receiving unit 110, a digital processing unit 120, an all-digital phase-locked loop (ADPLL) 160, and a clock source 170. A data packet DP may be received by the antenna 102 from the card 500. The analog receiving unit 110 may convert a received data packet DP using first and second local clocks CLCK1 and CLCK2 having different delayed phases from each other to a first data DTA1 or a second data DTA2. However, the number of local clocks having different delayed phases is not limited thereto. The converted data DTA1 or DTA2 may be provided to the digital processing unit 120. The conversions to the first data DTA1 and the second data DTA2 may be performed during at least a portion of the preamble transmission period PTP and the data transmission period DTP, respectively.

The ADPLL 160 may generate a plurality of local clocks CLCK having different delayed phases with respect to the carrier wave CW. The plurality of local clocks CLCK may include a first local clock CLCK1 having a 0 degree delayed phase and a second local clock CLCK2 having a 90 degree delayed phase during the carrier wave period 30 of FIG. 2.

The digital processing unit 120 may process the first and second data DTA1 and DTA2 and store the same. The digital processing unit 120 may analyze the first data DTA1 to determine a local clock CLCK_MAX that generates a maximum output power when it is mixed with a corresponding one of the plurality of sub patterns of the preamble section. The digital processing unit 120 may use the determined local clock CLCK_MAX to search the start pattern and receive the data section 60. Further, the digital processing unit 120 may process the second data DTA2 and store the same.

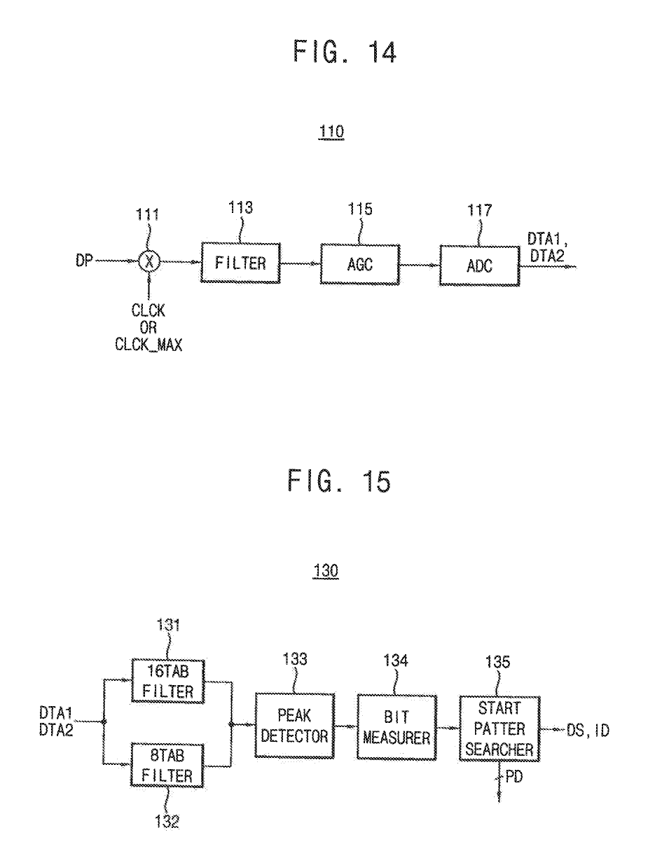

FIG. 14 is a block diagram illustrating the analog receiving unit of FIG. 13 according to an exemplary embodiment of the present inventive concept.

Referring to FIG. 14, the analog receiving unit 110 may include a mixer 111, a filter 113, an auto gain controller (AGC) 115, and an analog-to-digital converter (ADC) 115.

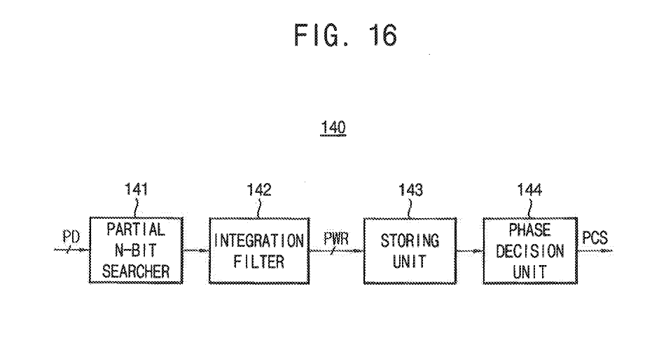

To generate the first data DTA1, for example, the mixer 111 may mix each of the plurality of sub patterns of the preamble section with a corresponding one of the plurality of local clocks CLCK. The filter 113 may filter an output of the mixer 111. The automatic gain controller (AGC) 115 may control a gain of the output of the filter 113. The analog-to-digital converter (ADC) 117 may generate the first data DTA1 by performing the analog-to-digital conversion to the output of the AGC 115. For example, the first data DTA1 may include a plurality of sub first data corresponding to one of the plurality of local clocks CLCK. The first data DTA may be provided to the digital processing unit 120, and further processed to determine the local clock CLCK_MAX. This process will be described more in detail with reference to FIGS. 15 to 16.

Further, to generate the second data DTA2, the mixer 111 may mix a data pattern of the data section with a local clock CLCK_MAX to be determined when the first data DTA1 is further processed. The filter 113 may filter an output of the mixer 111. The AGC 115 may control a gain of the output of the filter 113. The ADC 117 may generate the second data DTA2 by performing the analog-to-digital conversion to the output of the AGC 115.

Referring back to FIG. 13, the digital processing unit 120 may include a sampling block 130, a phase control unit 140, and a processor 150. The sampling block 130 may receive the first data DTA1 during the preamble transmission period PTP, search a pattern data PD in the first data DTA1, and provide the pattern data PD to the phase control unit 140. The pattern data PD may include the plurality of pattern data PD, each of which corresponds to one of the plurality of sub periods. For example, the plurality of pattern data PD may be generated by processing the plurality of sub first data, and accordingly relate to a power level of the plurality of sub first data. For example, the number of active bits of the pattern data PD may represent the power level of the first data DTA1. The sampling block 130 may receive the second data DTA2 during the data transmission period DTP, generate a detection signal DS and an internal data ID, and provide the same to the processor 150. Further, the processor 150 may receive the detection signal DS and the internal data ID, process the internal data signal ID based on the detection signal DS, and store the processed internal data ID. The detection signal DS may indicate a type of communication protocol to form the data packet DP and the internal data signal DS may correspond to the effective data in the data section 60.

The phase control unit 140 may use the pattern data PD to detect a power level of each of the plurality of local clocks CLCKS. For example, the pattern data PD may include a plurality of digital bits that represents the power level of each of the plurality of local clocks CLCK. The phase control unit 140 may provide a phase control signal PCS calculated based on the pattern data PD to the ADPLL 160. The phase control signal PCS may indicate the local clock CLCK_MAX. The ADPLL 160 may provide the local clock CLCK_MAX to the analog receiving unit 110. In addition, the sampling block 130 may search the start pattern using the local clock CLCK_MAX.

FIG. 15 is a block diagram illustrating the sampling block of FIG. 13 according to an exemplary embodiment of the present inventive concept.

Referring to FIG. 15, the second sampling block 130 may include filters 131 and 132, a peak detector 133, a bit measurer 134, and a start pattern searcher 135.

The filters 131 and 132 may filter the received first data DTA1 during at least the first preamble period of the preamble transmission period PTP and may filter the second data DTA2 during the data transmission period DTP. The peak detector 133 may perform a peak detection operation on outputs of the filters 131 and 132. The bit measurer 134 may perform a bit measuring operation on an output of the peak detector 133. The start pattern searcher 135 may analyze an output of the bit measurer 134 to generate the pattern data PD. The start pattern searcher 135 may analyze a mode pattern and a data pattern generated from the bit measurer 134 to generate the detection signal DS and the internal data signal ID during the data transmission period DTP.

FIG. 16 is a block diagram illustrating the phase control unit in FIG. 13 according to an exemplary embodiment of the present inventive concept.

Referring to FIG. 16, the phase control unit 140 may include a partial bit searcher 141, an integration filter 142, a storing unit 143, and a phase decision unit 144.

The partial bit searcher 141 may search partial bits of N-bit (N is a positive integer equal to two or greater) of the pattern data PD during the first preamble period of the preamble transmission period PTP. The integration filter 142 may perform an integral operation to count the number of searched bits at the partial bit searcher 141. Output of the integration filter 142 may provide power levels of the mixed signals generated using the plurality of local clocks CLCK. The storing unit 143 may store the obtained powers PWR. The phase decision unit 144 may compare the powers PWR stored in the storing unit 143 with each other, and thus, determine the local clock CLCK_MAX that generates a maximum mixed signal power. Further, the phase decision unit 144 may provide a phase control signal PCS indicating the local clock CLCK_MAX to the ADPLL 160.

As mentioned above, since the reader 100 receives the data packet from the card 500 using one channel, resources to process the data packet may be reduced and a receiving efficiency may be increased by receiving the data packet using the local clock CLCK_MAX that generates a maximum power when it is mixed with one of the sub patterns. For example, the channel may be a pair of an analog receiving unit 110, a digital processing unit 120, an ADPLL 160, and a clock source 170, to be required to receive the data packet. Accordingly, an exemplary embodiment of the present inventive concept may reduce the number of components required in the reader 100.

When the reader 100 receives the data packet DP formed according to the TypeA 106 protocol or the TypeB 106 protocol, the phase control unit 140 may divide the first preamble period 51a of the preamble transmission period PTP into the plurality of sub periods M11, M12, M13 and M14. Here, the sub periods M11, M12, M13, and M14 may include a corresponding one of the plurality of sub patterns. The phase control unit 140 may obtain power levels of a plurality of signals generated by mixing each of the plurality of sub patterns with a corresponding one of the plurality of local clocks. The mixing each of the plurality of sub patterns with a corresponding one of the plurality of local clocks may be performed during each of the sub periods M11, M12, M13 and M14. Further, the phase control unit 140 may determine the local clock CLCK_MAX that generates a maximum output power when it is mixed with a corresponding one of the plurality of sub patterns of the preamble section. The sampling block 130 may use the determined maximum local clock CLCK_MAX to search the start pattern 61a during the second preamble period 53a and receive the data section 60a from the card 500. However, the number of sub periods of the preamble transmission period PTP or plurality of local clocks is not limited. For example, the phase control unit 140 may divide the first period 51b of the preamble section PTP into the first and second sub periods M21 and M22 as illustrated in FIG. 11. Here, the sub periods M21 and M22 may include a corresponding one of two sub patterns. The phase control unit 140 may obtain power levels of two signals generated by mixing each of the two sub patterns with a corresponding one of first and second local clocks during each of the first and second sub periods M21 and M22. Here, the first and second local clocks may have a 0 degree delayed phase and a 90 degree delayed phase, respectively. Further, the phase control unit 140 may determine the local clock CLCK_MAX that generates a maximum output power when it is mixed with a corresponding one of the two sub patterns of the preamble section. In this case, the sampling block 130 may receive the data section 60b from the card 50 by searching the start pattern 61b using the determined local clock CLCK_MAX during the second period 53b.

When the reader 100 receives the data packet DP formed according to the TypeF 212 protocol or the TypeF 424 protocol, the phase control unit 140 may divide the entire period of the preamble transmission period PTP into the plurality of sub periods M31, M32, M33 and M34. The sub periods M31, M32, M33, and M34 may include a plurality of sub patterns. The phase control unit 140 may obtain power levels of a plurality of signals generated by mixing each of the plurality of sub patterns with a corresponding one of the plurality of local clocks. The mixing each of the plurality of sub patterns with a corresponding one of the plurality of local clocks may be performed during each of the sub periods M31, M32, M33 and M34. Further, the phase control unit 140 may determine a maximum local clock CLCK_MAX that generates a maximum output power when it is mixed with one of the plurality of sub patterns in the preamble transmission period PTP. Further, the sampling block 130 may use the determined maximum local clock CLCK_MAX to search the sync pattern 61c as a start pattern during the period 53c and receive the data section 60c from the card 500.

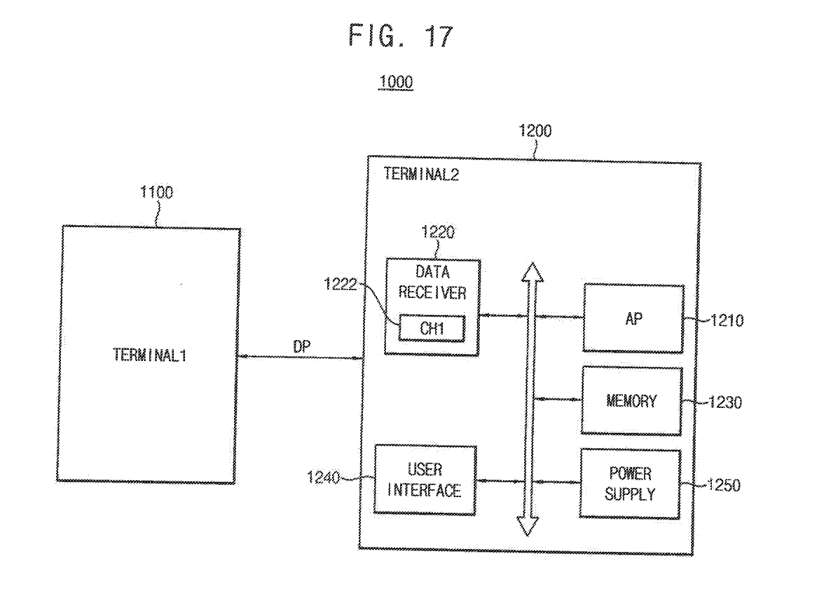

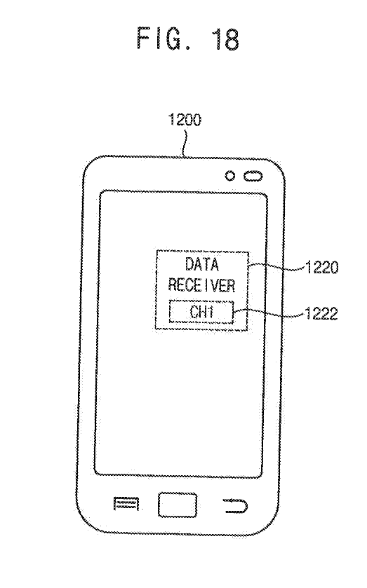

FIG. 17 is a block diagram illustrating a wireless communication system including a wireless data receiver according to an exemplary embodiment of the present inventive concept. FIG. 18 illustrates a second terminal of the wireless communication system shown in FIG. 17, according to an exemplary embodiment of the present inventive concept.

Referring to FIGS. 18 and 19, a wireless communication system 1000 may include a first terminal 1100 and a second terminal 1200.

The first terminal 1100 and the second terminal 1200 may exchange a data packet DP. For example, the first terminal 1100 may serve as a card (or target) and the second terminal 1200 may serve as a reader (or initiator), or vice versa.

The second terminal 1200 may receive the data packet DP transmitted from the first terminal 1100. The second terminal 1200 may include a wireless data receiving device 1220 and further include an application processor 1210, a memory device 1230, a user interface 1240, and a power supply 1250.

For example, the second terminal 1200 may be a mobile device such as a mobile phone, a smart phone, a tablet computer, a laptop computer, a PDA, a PMP, a digital camera, a portable game console, a music player, a camcorder, a video player, a GPS, or the like.

The application processor 1210 may include an operating system (OS) to drive the second terminal 1200. In addition, the application processor 1210 may execute applications such as an internet browser, a game application, a video player application, or the like. According to an exemplary embodiment of the present inventive concept, the application processor 1210 may include one processor core. In an embodiment, the application processor 1210 may further include a cache memory located inside or outside the application processor 1210.

The memory device 1230 may store data processed by the application processor 1210, and serve as a working memory. The memory device 1230 may store a boot image therein that boots the second terminal 1200, a file system associated with the OS, a device driver associated with an external device (not shown) connected to the second terminal 1200, and an application program executed by the second terminal 1200. For example, the memory device 1230 may include a volatile memory such as a DRAM, a SRAM, a mobile DRAM, or the like. The memory device 1230 may include a nonvolatile memory such as an electrically erasable programmable read-only memory (EEPROM), a flash memory, a PRAM, a RRAM, a MRAM, a FRAM, a nano floating gate memory (NFGM), a polymer random access memory (PoRAM), or the like.

The user interface 1240 may include at least one input device such as a keypad, a touch screen, or the like, and further include at least one output device such as a speaker, a display device, or the like. The power supply 1250 may supply an operating power to the second terminal 1200. The second terminal 1200 may further include a baseband chipset or an image sensor.

Since, the wireless data receiving device 1220 may have substantially same configurations as the wireless data receiving device 101 in FIG. 13. For example, the wireless data receiving device 1220 may include an analog receiving unit, a digital processing unit, and an ADPLL. The analog receiving unit may receive a data packet from a first terminal 1100, convert the data packet to first data during the preamble transmission period PTP to provide the first data to the digital processing unit and convert the data packet to the second data during the data transmission period DTP to provide the second data to the digital processing unit. The ADPLL may generate a plurality of local clocks having different delayed phases with respect to the carrier wave during the carrier wave period. The plurality of local clocks may include a first local clock having a 0 degree delayed phase and a second local clock having a 90 degree delayed phase. The carrier wave period may be defined as a period in which the wireless data receiving device 1220 may transmit the carrier wave to the first terminal 1100. The digital processing unit may obtain power levels of signals generated by mixing each of two sub patterns in the preamble transmission period with a corresponding one of the generated first and second local clocks, determine a local clock CLK_MAX that generates a maximum power when it is mixed with one of the two sub patterns, and search a start pattern to receive a data section using the determined local clock CLK_MAX. In addition, the digital processing unit may process the second data and stores the second data during the data transmission period DTP. Accordingly, the wireless data receiving device 1220 may receive the data packet DP using the first and second local clocks. In addition, the wireless data receiving device 1220 may receive the data packet DP through one channel 1222 when the wireless data receiving device 1220 may receive the data packet DP using the plurality of local clocks, resources to process the data packet may be reduced and a receiving efficiency may be increased by receiving the data packet using the local clock CLCK_MAX that generates a maximum power when it is mixed with one of the sub patterns.

According to an exemplary embodiment of the present inventive concept, the second terminal 1200 or components therein may be packaged in various forms such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), wafer-level processed stack package (WSP), or the like.

Although not shown in the drawings, the wireless communication system 1000 may be a bidirectional system in which reading and writing are performed by either of the first terminal 1100 or the second terminal 1200. Accordingly, the first terminal 1100 may include the data receiving device 1220 according to an exemplary embodiment of the present inventive concept, and thus, serve as a reader (or initiator) as well as a card (or target). The first terminal 1100 may further include such as a processor, a memory device, a user interface, or a power supply. Exemplary embodiments of the present inventive concept may be applied to a terminal for NFC such as a mobile phone, a smart phone, a tablet PC, a laptop computer, a personal digital assistant (PDA), a portable multimedia player (PMP), a digital camera, a music player, a portable game console, a navigation system, or the like.

Although a few embodiments of the present inventive concept have been described, it will be understood by those skilled in the art that various modifications in form and details may be made therein without departing from the spirit and scope of the present inventive concept as defined by the following claims. Therefore, it may be understood that the foregoing is illustrative of the present inventive concept and should not be construed as being limited to the specific embodiments disclosed herein.

What is claimed is:

1. A method of receiving wireless data, the method comprising:
generating a plurality of local clocks having different delayed phases with respect to a carrier wave during a carrier wave period; and
receiving a data packet using the plurality of local clocks,
wherein the plurality of local clocks includes a first local clock and a second local clock,
wherein the first local clock has a 0 degree delayed phase with respect to the carrier wave,
wherein the second local clock has a 90 degree delayed phase with respect to the carrier wave.

2. The method of claim 1, wherein the receiving the data packet comprises:
obtaining power levels of a plurality of signals generated by mixing each of a plurality of sub patterns of a preamble pattern with a corresponding one of the plurality of local clocks,
wherein the preamble pattern is located in a preamble transmission period of the data packet;
determining a local clock that generates a maximum power level based on the obtained power levels;
searching a start pattern based on the determined local clock that generates the maximum power level; and
receiving a data section of the data packet based on the searched start pattern.

3. The method of claim 2, wherein the preamble transmission period includes a first preamble period and a second preamble period,
wherein each of the power levels of the plurality of signals is obtained during a corresponding one of a plurality of sub periods of the first preamble transmission period,
wherein the start pattern is searched during the second preamble period following the first preamble period.

4. The method of claim 3, wherein each of the plurality of local clocks corresponds to one of the plurality of sub patterns,
wherein each of the plurality of sub patterns corresponds to one of the plurality of sub periods,
wherein each of the plurality of sub periods corresponds to one of the plurality of signals.

5. The method of claim 3, wherein the received data packet is formed according to a TypeA 106 communication protocol or a TypeB 106 communication protocol.

6. The method of claim 2, wherein each of the power levels of the plurality of signals is obtained during a corresponding one of a plurality of sub periods in the entire preamble transmission period,
wherein the start pattern is searched during a synchronization period following the preamble transmission period.

7. The method of claim 6, wherein each of the plurality of local clocks corresponds to one of the plurality of sub patterns,
wherein each of the plurality of sub patterns corresponds to one of the plurality of sub periods,
wherein each of the plurality of sub periods corresponds to one of the plurality of signals.

8. The method of claim 6, wherein the received data packet is formed according to a TypeF 212 communication protocol or a TypeF 424 communication protocol.

9. A wireless data receiving device comprising:
an all digital phase-locked loop (ADPLL) configured to generate a plurality of local clocks having different delayed phases with respect to a carrier wave during a carrier wave period; and
an analog receiving unit configured to receive a data packet using the plurality of local clocks,
wherein the plurality of local clocks includes a first local clock and a second local clock,
wherein the first local clock has a 0 degree delayed phase with respect to the carrier wave,
wherein the second local clock has a 90 degree delayed phase with respect to the carrier wave.

10. The wireless data receiving device of claim 9, wherein the analog receiving unit is configured to convert the data packet into first data during a plurality of sub periods in a preamble transmission period or second data during a data transmission period,
wherein the first data includes a plurality of sub first data generated by at least mixing each of a plurality of sub patterns of a preamble pattern with a corresponding one of the plurality of local clocks,
wherein the preamble pattern is located in the preamble transmission period of the data packet.

11. The wireless data receiving device of claim 10 further comprising: a digital processing unit, wherein the digital processing unit comprises a phase control unit configured to obtain power levels of the plurality of sub first data,
wherein the phase control unit is configured to determine a local clock that generates a maximum power level based on the obtained power levels.

12. The wireless data receiving device of claim 11, wherein each of the plurality of local clocks corresponds to one of the plurality of sub patterns,
wherein each of the plurality of sub patterns corresponds to one of the plurality of sub periods,
wherein each of the plurality of sub periods corresponds to one of the plurality of sub first data.

13. The wireless data receiving device of claim 12, wherein the digital processing unit further comprises a sampling block configured to search a start pattern using the determined local clock that generates the maximum power level, to receive a data section of the data packet based on the searched start pattern, and to generate a detection signal and an internal data signal.

14. The wireless data receiving device of claim 13, wherein the sampling block further comprises:
a plurality of filters configured to filter the first data and the second data;
a peak detector configured to perform a peak detecting operation on outputs of the plurality of filters;
a bit measurer configured to perform a bit measuring operation on an output of the peak detector; and
a start pattern searcher configured to analyze an output of the bit measurer, to generate a plurality of pattern data based on the plurality of sub first data, and to generate the detection signal and the internal data signal based on the second data.

15. The wireless data receiving device of claim 14, wherein the phase control unit comprises:
a partial bit searcher configured to search partial bits of N bits of each of the plurality of pattern data, wherein N is a positive integer equal to two or greater;
an integration filter configured to integrate the searched partial bits and obtain the power levels of plurality of sub first data;
a storing unit that stores the obtained power levels; and
a phase decision unit configured to determine the local clock that generates the maximum power level based on the power levels stored in the storing unit, and to provide a phase control signal to the ADPLL,
wherein the phase control signal indicates the local clock that generates the maximum power level.

16. The wireless data receiving device of claim 10, wherein the preamble transmission period includes a first preamble period and a second preamble period,
wherein the plurality of sub periods is located in the first preamble period of the preamble transmission period when the received data packet is formed according to a TypeA 106 communication protocol or a TypeB 106 communication protocol.

17. The wireless data receiving device of claim 10, wherein the plurality of sub periods is located in the entire preamble transmission period when the received data packet is formed according to a TypeF 212 communication protocol or a TypeF 242 communication protocol.

18. A wireless data receiving device comprising:
an all digital phase-locked loop (ADPLL) configured to generate a plurality of local clocks having different delayed phases with respect to a carrier wave during a carrier wave period;
an analog receiving unit configured to receive a data packet, to mix each of a plurality of a sub patterns of a preamble pattern with a corresponding one of the plurality of local clocks, and to generate each of a plurality of sub first data during a corresponding one of a plurality of sub periods of a preamble transmission period; and
a digital processing unit configured to determine a maximum local clock of the plurality of local clocks based on the plurality of sub first data, and to provide information of the maximum local clock to the ADPLL,
wherein the maximum local clock is a local clock mixed with a sub first data having a maximum power level,
wherein the plurality of local clocks includes a first local clock and a second local clock,
wherein the first local clock has a 0 degree delayed phase with respect to the carrier wave,
wherein the second local clock has a 90 degree delayed phase with respect to the carrier wave,
wherein the preamble pattern is located in the preamble transmission period.

19. The wireless data receiving device of claim 18, wherein the digital processing unit further comprises a phase control unit configured to obtain power levels of the plurality of sub first data, and to determine the maximum local clock based on the obtained power levels.

20. The wireless data receiving device of claim 18, wherein the preamble transmission period includes a first preamble period and a second preamble period,
wherein each of the plurality of sub patterns corresponds to one of the plurality of sub period,
wherein the plurality of sub periods is located in the first preamble period of the preamble transmission period when the received data packet is formed according to a TypeA 106 communication protocol or a TypeB 106 communication protocol.
